(19) United States
(12) Patent Application Publication
(10) Pub. No.: US 2004/0249320 A1
(43) Pub. Date: Dec. 9, 2004

(54) Cosmetic treatment device and cosmetic treatment tip used for the device

(76) Inventors: Iwao Yamazaki, Tokyo (JP); Akitsugu Yamazaki, Tokyo (JP); Kimiyo Yamazaki, Tokyo (JP)

Correspondence Address: Finnegan Henderson Farabow, Garrett & Dunner, 1300 I Street NW, Washington, DC, 20005, US

(21) Appl. No.: 10/485,730

(22) PCT Filed: Apr. 15, 2002
(86) PCT No.: PCT/JP02/03739

(30) Foreign Application Priority Data
Sep. 11, 2001 (JP) 2001-344960

(51) Int. Cl. A61H 1/00

(52) U.S. Cl. 601/46

(57) ABSTRACT

A beauty treating device is provided with a device body 1 in which a motor 3 having an eccentric rotor 2 built as a vibration generating section. A beauty treating chip 10 is fixed to a leading end of the device body 1 to conduct vibration from the vibration generating section. The beauty treating chip 10 is kept vibrating and contacted to the skin surface of a user so to penetrate the beauty treating agent into the skin of the user. The beauty treating chip 10 has a porous base material, and the beauty treating agent is impregnated and kept in the porous base material. For the beauty treating chip, a chip shaped whetstone which is formed of ceramics abrasive grains having a particle size in a range of #80 to #800 can also be applied.

### TECHNICAL FIELD

The present invention relates to a beauty treating device to be used for various beauty treatments and a beauty treating chip to be applied to it.

### BACKGROUND ART

For skin-beauty treatments such as facial treatment, makeup, removal or suppression of liver spots, dullness, wrinkles or pimples and protection of the skin, a portion of human skin to be treated is penetrated with a beauty liquid, a cosmetic liquid, a skin protection liquid, a medical agent or the like. To penetrate a beauty treating agent such a beauty liquid or a cosmetic liquid into the skin, it is generally known that a cotton or the like is impregnated with the beauty treating agent and held in contact with the skin surface to be treated or repeatedly pressed to the skin (hereinafter called as patting).

For penetration of the beauty treating agent into the skin, mechanical vibration, ultrasonic vibration and application of an electric field are also employed so to improve a penetration efficiency of the beauty treating agent. For example, Japanese Registered Utility Model Publication No. 3000144 describes a beauty treating device which has a treating section having a smooth coating (gilding or hard chrome plating) for penetration of a beauty liquid fixed to a device body in which a motor having an eccentric rotor is built. The beauty liquid is penetrated by previously applying the beauty liquid to a portion of human skin to be treated and pressing a vibrating treating section to the pertinent portion.

Japanese Patent Application Laid-Open Publication No. 2000-217881 discloses a beauty appliance which has a disk-shape electrode mounted at a tip of a probe having a built-in ultrasonic oscillator to enable the application of vibration by the disk-shape electrode and also an electric field by a DC voltage to the skin of a user. Here, a beauty treating agent is first applied to the subject portion of the skin, and the disk-shape electrode is pressed to the portion of skin to which the beauty treating agent is applied to promote the penetration of the beauty treating agent into the skin.

As described above, for the penetration of the beauty treating agent into the skin, not only manual patting but also the beauty treating device employing the application of mechanical vibration, ultrasonic vibration or an electric field have been used. However, the conventional beauty treating devices require previous application of the beauty treating agent to a subject portion of human skin, so that an adequate penetration efficiency of the beauty treating agent is not necessarily attained. Besides, a penetrated amount of the beauty treating agent may be variable depending on the users because it is susceptible to an amount (application amount) of the beauty treating agent previously applied to the skin.

Under the circumstances described above, it is desired to realize a beauty treating device which can efficiently penetrate the beauty treating agent into the skin and has improved controllability of a penetration amount of the beauty treating agent. Furthermore, it is demanded that the cost must be reduced in order to enhance the convenience of the beauty treating device so to enable individuals to use it.

Meanwhile, as to a device which performs the beauty treatment by applying vibration to the human body, for example, Japanese Registered Utility Model Publication No. 3000144 describes a beauty treating device which has a ceramics material (treating chip) with a coarse surface for removing aging horny cells securely fixed to a device body which has a built-in motor with an eccentric rotor. For the treating chip, a ceramics sintered body of alumina, zirconia or magnesia is used.

The aforementioned beauty treating device is to remove the aging horny cells by pressing the mechanically vibrated treating chip to the skin, thereby promoting a regeneration function of skin. Specifically, the horny cells, which are at the uppermost portion of epidermis, are sequentially formed as cells newborn at the basal cells of the lowermost portion of the epidermis are pushed upward and diffused, and inside keratohiarin is transformed (keratohiarin metabolizing). The outermost horny cells of the epidermis sequentially become like scales and finally become horny cell pieces (dirt) and sloughed off from the epidermis.

Thus, the skin originally has the regeneration ability, and a cycle that epidermis cells are newly born and shed is called a turnover of epidermis. If the turnover is not normally made because of aging, ultraviolet exposure, drying, stress and the like, liver spots, dullness, wrinkles, stretch marks and the like tend to be formed. Therefore, it is common to perform that mechanical vibration is given to the aged horny layer on the outermost layer of the epidermis to partly remove the aged horny cells, thereby promoting the regeneration function (turnover) of the skin.

The regeneration promoting treatment of skin is effective at removing liver spots, dullness, wrinkles, stretch marks and the like, and also effectively acts on aging prevention of skin. Especially, the regeneration promoting treatment of skin by mechanical vibration has features that the skin is not heavily damaged and can be treated partly.

But, there are concerns that when the surface of a treating chip which is directly contacted to the skin is excessively coarse or excessively hard, for example, the aged horny cells are not removed uniformly or damage to the skin increases. Simple smoothening of the surface of the treating chip lowers the effect of the skin regeneration treatment. Consequently, it is demanded that the promotion effect of the skin regeneration function is improved, and damage to the skin is minimized.

Devices for performing the beauty treatment by giving vibration to the skin are disclosed in Japanese Registered Utility Model Publications No. 3004388 and No. 3041063, Japanese Patent Application Laid-Open Publication No. HEI 4-117965. The devices described in Japanese Registered Utility Model Publications No. 3004388 and No. 3041063 are devices which apply vibration to the body to provide a massage effect. The beauty treating device described in Japanese Patent Application Laid-Open Publication No. HEI 4-117965 is a device which applies an electrical stimulation by an AD voltage or the like and ultrasonic vibration to skin. The above devices are not considered to perform a penetration treatment of a beauty treating agent or a regeneration promoting treatment of skin.

It is an object of the present invention to provide a beauty treating device which is provided with enhanced controllability of a penetration efficiency and a penetration amount of a beauty treating agent such as a beauty liquid or a cosmetic liquid into skin, low in cost and usable with ease, and a beauty treating chip to be used for it. Another object of the invention is to provide a beauty treating device which is provided with an improved effect of promoting the skin regenerating function and can control a damage to the skin.

### DISCLOSURE OF THE INVENTION

A first beauty treating device of the present invention is comprised of a device body; a vibration generating section which is built in the device body; and a beauty treating chip, to which vibration is conducted from the vibration generating section, which is contacted to a surface of skin to be undergone a beauty treatment to apply the vibration to it, and which has a porous base material and a beauty treating agent impregnated into the porous base material.

The beauty treating chip of the invention is a beauty treating chip which is contacted to a surface of skin so to penetrate the beauty treating agent into body and provided with a porous base material and the beauty treating agent impregnated into the porous base material.

The beauty treating agent contained in the beauty treating chip of the invention is not particularly limited, various types of beauty treating agents suitable for the target beauty treatment can be used. Such beauty treating agents include, for example, a beauty treating agent containing as a main target component at least one kind which is selected from a beauty component, a cosmetic component, a skin protecting component and the like, and a beauty treating agent which contains as an accessory ingredient at least one kind selected from a fragrance, a pigment and the like.

The present invention uses the beauty treating chip which has the beauty treating agent, which is penetrated into the body, previously impregnated into the porous base material. The beauty treating agent can be penetrated efficiently into the body by performing various types of beauty treatments by means of the beauty treating chip which is previously impregnated with the beauty treating agent and finely vibrated. The penetration amount of the beauty treating agent can be controlled by adjusting an impregnation amount of the beauty treating agent into the beauty treating chip, a frequency to be applied to the beauty treating chip, the hardness and strength (an amount of wear-out of the chip) of the beauty treating chip, and the like. Therefore, it becomes possible to improve controllability of a penetration amount of the beauty treating agent and a beauty treating effect depending on it as compared with a conventional device which is used with the beauty treating agent applied to skin in advance.

A second beauty treating device of the present invention is comprised of a device body; a vibration generating section which is built in the device body; and a beauty treating chip, to which vibration is conducted from the vibration generating section, which is contacted to a surface of skin to be undergone a beauty treatment to apply the vibration to it, and which is provided with abrasive grains having a grain size in a range of #80 to #800 according to JIS R6001. Another beauty treating device according to the invention is provided with a beauty treating chip having alumina abrasive grains.

Specific examples of the beauty treating chip include a chip whose abrasive grains are bonded by a binder so that the abrasive grains maintain the chip shape. The beauty treating device having the above beauty treating chip is used to a skin regeneration promoting treatment. Besides, it can also be used for a treatment to remove dirt adhered to the surface of skin.

The abrasive grains having the aforementioned grain size delivers appropriate performance to remove a part of dirt adhered to the skin surface and aged horny cells when the treatment is performed by applying fine vibration to the beauty treating chip. Thus, the beauty treating chip formed of the abrasive grains can be used to perform the skin regeneration promoting treatment uniformly and efficiently without damaging the skin. And, dirt adhered to the surface of skin can also be removed efficiently. Especially, the alumina abrasive grains are quite safe to the body and low in damageability, the treatment can be made safely even when a user has weak skin or sensitive skin.

### BRIEF DESCRIPTION OF THE DRAWINGS

FIG. 1 is a front view showing an external appearance of one embodiment of a first beauty treating device according to the present invention.

FIG. 2 is a side view of the beauty treating device shown in FIG. 1.

FIG. 3 is a sectional diagram showing a structure of the beauty treating device shown in FIG. 1.

FIG. 4 is a sectional diagram showing a modified example of the beauty treating device shown in FIG. 1.

FIG. 5 is a sectional diagram showing a structure of one embodiment of a second beauty treating device of the present invention.

FIG. 6 is a front view showing an external appearance of one embodiment of another beauty treating device of the present invention.

### BEST MODE FOR CARRYING OUT THE INVENTION

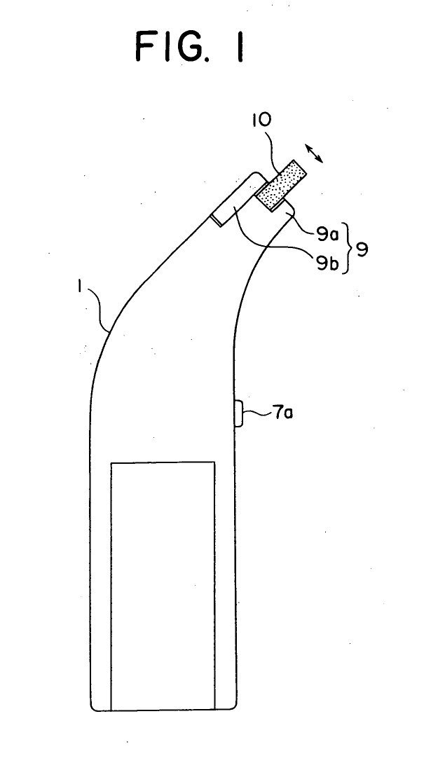

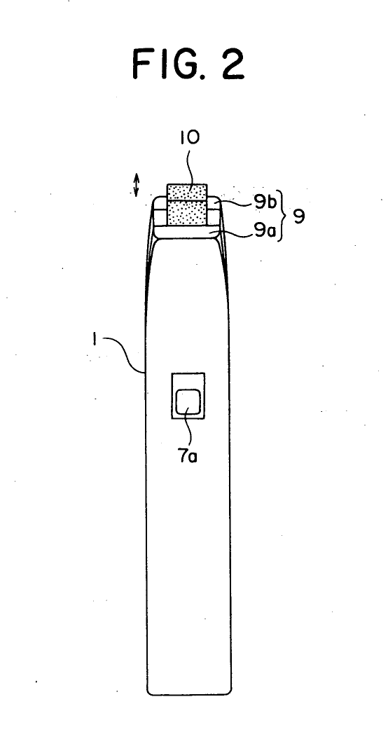

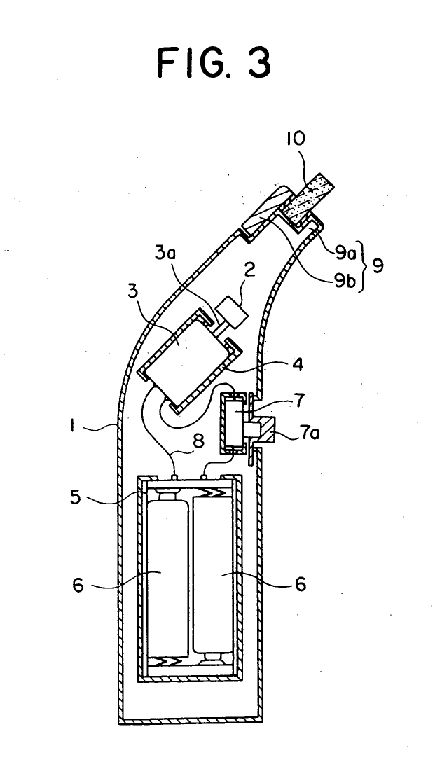

Embodiments of the present invention will be described. FIG. 1, FIG. 2 and FIG. 3 are diagrams showing the configuration of one embodiment of a first beauty treating device of the invention. FIG. 1 is a front view showing the appearance of the beauty treating device, FIG. 2 is its side view, and FIG. 3 is a sectional view of the beauty treating device. In these drawings, 1 is a device body made of a non-conductive material such as a plastic material, and the device body 1 has a motor 3 with an eccentric rotor 2 as a vibration generating section built into it.

Specifically, a motor housing 4 is integrally formed in the device body 1, and the compact DC motor 3 is mounted in the motor housing 4. The eccentric rotor 2 is fixed to a shaft 3a of the compact DC motor 3. A power supply 5 is also disposed within the device body 1 and houses, for example, two batteries 6, 6, as the DC power source in it. The compact DC motor 3 and the power supply 5 are electrically connected to each other via a switch section 7 which has a changeover switch 7a fitted on the outer surface of the device body 1. Reference numeral 8 in the drawings denotes wiring.

The compact DC motor 3 having the eccentric rotor 2 as the vibration generating section is driven to rotate the eccentric rotor 2 so to vibrate the device body 1. Specifically, when the compact DC motor 3 is driven, the eccentric rotor 2 rotates, and the device body 1 is vibrated by the rotation of the eccentric rotor 2. This vibration generating mechanism finely vibrates the device body 1 in desired directions.

This embodiment shows the beauty treating device using the compact DC motor 3 provided with the eccentric rotor 2 as the vibration generating section, but the vibration generating section used in the invention is not limited to the above. For example, various types of vibration generating means such as an ultrasonic vibrator, a piezoelectric element and the like can be used. Thus, various types of vibration generating means can be used in this invention.

Among them, the compact DC motor 3 having the eccentric rotor 2 can easily control a frequency of vibration according to the speed of the motor 3 and an amplitude of vibration depending on the size and mass of the eccentric rotor 2, and can generate fine vibration at various frequencies. Therefore, the compact DC motor 3 having the eccentric rotor 2 can be desirable vibration generating means. The motor 3 which rotates the eccentric rotor 2 is not limited to a battery-driven type, and a motor which is driven by AC or DC power supplied by an external power source may be used. But, the battery-driven compact DC motor 3 is effective in improving portability of the beauty treating device.

A chip fixing mechanism 9 is fitted to the leading end of the device body 1. The beauty treating chip 10 is removably held by the chip fixing mechanism 9. Specifically, the chip fixing mechanism 9 has pinching sections 9a, 9b. The beauty treating chip 10 is inserted between the pinching sections 9a, 9b. The beauty treating chip 10 is fixed to the device body 1 by tightening the pinching sections 9a, 9b to secure the beauty treating chip 10.

Here, the beauty treating chip 10 has a rectangular shape, but the chip shape is not especially limited. For example, the beauty treating chip 10 can have a variety of shapes such as an arc shape skin contact face, or a cylindrical shape or a sphere shape as the entire chip. Besides, the beauty treating chip 10 is not limited to a single member but the beauty treating device may have a plurality of beauty treating chips 10 as described later in detail. In such a case, a plurality of chip fixing mechanisms 9 are used.

And, vibration generated by the compact DC motor 3 having the eccentric rotor 2 is conducted to the beauty treating chip 10, which is fixed to the device body 1, through the device body 1. The beauty treating device is configured to vibrate the beauty treating chip 10 at a frequency and amplitude depending on various beauty treating conditions according to the vibration conducted through the device body 1. The compact DC motor 3 having the eccentric rotor 2 is determined to have a mounting position, direction and the like to apply mainly reciprocating vibration to, for example, the beauty treating chip 10 as indicated by the arrow in the drawings.

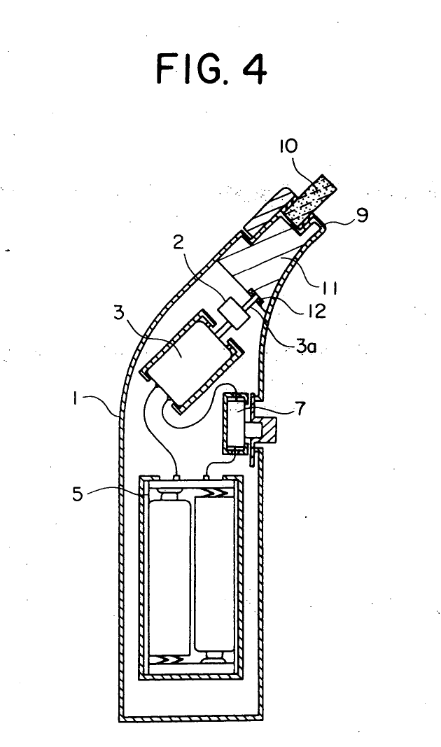

The vibration conducting mechanism to the beauty treating chip 10 is not limited to the one shown in FIG. 3, and various types of mechanisms can be used. For example, the beauty treating device shown in FIG. 4 has a vibration conducting member 11 inserted into a space provided at the tip portion of the device body 1. Another end of the shaft 3a having the eccentric rotor 2 is supported by a bearing 12 which is fixed to the vibration conducting member 11. In other words, the vibration conducting member 11 is located between the eccentric rotor 2 and the beauty treating chip 10. According to this device mechanism, vibration based on the rotations of the eccentric rotor 2 can be conducted more effectively to the beauty treating chip 10. Furthermore, vibration generated by the compact DC motor 3 having the eccentric rotor 2 may be conducted directly to the beauty treating chip 10 without through the device body 1.

The beauty treating chip 10 to be used for the aforementioned beauty treating device has a porous base material which keeps the chip shape and is impregnated with the beauty treating agent. This beauty treating chip 10 is vibrated at a frequency and an amplitude according to the target beauty treating conditions. The beauty treating chip 10 being vibrated is contacted to the skin surface of a user to perform the beauty treatment to penetrate the beauty treating agent, which is impregnated into the beauty treating chip 10, into the body. The beauty treating agent is oozed out of the beauty treating chip 10 due to vibration and an impact of the contact (patting) to the skin and penetrated into the skin by the vibration of the chip 10.

The porous body used as a base material of the beauty treating chip 10 may be a porous base material formed of any type of material if it can keep the beauty treating agent and has safety to the human body. Here, the keeping of the beauty treating agent does not indicate a state that the beauty treating agent is completely sealed in the porous base material but includes a state that the beauty treating agent is naturally oozed out or gushed out little by little depending on the used state of the beauty treating chip 10. The porous base material is not limited to a material which holds the beauty treating agent in its pores. It may be a material which absorbs the beauty treating agent in addition to the holding in the pores.

An amount of holes (porous level) of the porous base material can be determined appropriately depending on a type of beauty treating agent or target beauty treating conditions if the porous base material has a sufficient handling strength. An amount of impregnation of the beauty treating agent is variable depending on what porous base material is used. Therefore, it is desirable to determine the porous level with the above conditions taken into account. Besides, hardness and strength of the porous base material can be determined appropriately depending on the beauty treating conditions, part of human skin subjected to the beauty treatment, and the like. For example, the porous base material may have such hardness and strength that it is worn gradually to increase an oozing amount (an amount of penetration into the body) of the beauty treating agent, or the porous base material may have hardness and strength to resist a damage.

Specific examples of the aforementioned porous base material include porous ceramics, porous resin (e.g., foam resin), porous rubber (e.g., foam rubber), and the like. In addition, the porous body made of any type of material can be used if it has safety conforming to the beauty treating conditions, the holding property of the beauty treating agent, an ooze-out property and the like. Examples of the porous ceramics include a porous sintered body of a ceramics material, a porous aggregate of a ceramics material, and the like. By controlling the sintering conditions, a type of binder and other conditions, the porous base material having various types of porous levels (amount of holes), hardness, strength and the like can be obtained relatively easily. The porous ceramics is suitable for the porous base material of the beauty treating chip 10.

Examples of the ceramics material applied to the porous base material include alumina, zirconia, magnesia, spinel, silicon carbide, silicon nitride, boron nitride and the like. Among them, oxide ceramics materials which are highly safe to the human body, such as alumina, zirconia, magnesia and spinel, are preferably used. Especially, alumina excels in safety, is low in attack to the human body and provides an appropriate massage effect. Therefore, it is suitable as a configuring material of the porous base material for the beauty treating chip 10.

The porous sintered body of the ceramics material can be obtained by appropriately selecting a mixing amount of a resin binder component and sintering conditions for producing a formed item. Besides, it is possible to control conditions such as hardness, a porous level and the like of the porous sintered item. Examples of the porous aggregate of the ceramics material include a porous body which has ceramics particles (powder) bonded by a vitrified binder or the like. The above aggregate is produced by mixing ceramics powder with a vitrified binder, forming the mixture into a desired chip shape, and sintering it at a temperature of about 1200 to 1350° C. for example. The porous aggregate having a variety of porous levels and hardness can be obtained by appropriately determining a type and a mixing amount of the vitrified binder.

To produce the porous aggregate using the vitrified binder, it is effective to have the ceramics particles previously treated with an acid liquid such as hydrochloric acid, sulfuric acid, nitric acid, hydrofluoric acid or an acid mixture thereof. The acid treatment of the ceramics particles can improve safety (sterilization effect) of the particles themselves. Besides, sharp projections and the like on the surface of ceramics particles are smoothened to some extent, and an attack to the skin can be lowered furthermore. For bonding and holding of the ceramics particles, for example, a rubber-based binder, a resin-based binder, a glass-based binder, a metal-based binder, and other various types of binders can be used.

The beauty treating chip 10 is configured by impregnating a liquid beauty treating agent into the aforementioned porous base material. Impregnation and holding of the liquid beauty treating agent are performed by immersing the porous base material in the beauty treating agent (liquid). Besides, the beauty treating agent can be filled in the porous base material at a high density by applying vacuum impregnation.

The beauty treating agent to be impregnated into the porous base material can be suitably selected from a beauty liquid, a cosmetic liquid, a skin protection liquid, a facial cleansing liquid and the like depending on the target beauty treatment and is not limited to a particular type. Besides, the beauty treating agent is not limited to a liquid type and may contain a powder or particle treating agent. Such an agent may be previously dissolved or dispersed into a liquid (a beauty treating liquid, a solvent or the like), so that it can be impregnated and kept in the porous base material.

As the beauty treating agent, those containing beauty components such as various kinds of vitamins, seramide and collagen (including collagen beads etc.), cosmetic components used as various kinds of cosmetics, or a skin protecting component such as a sunscreen can be used, and one also containing a facial cleansing component can be used depending on the situation. Each of such components can be used alone or as a mixture of two or more of them. Besides, in addition to the above main target components of the beauty treating agent, a component having anti-inflammatory effects may be contained, and a fragrance or a pigment may be added as accessory ingredients.

For vitamins as the main target components for the beauty treating agent, vitamin A oil (vitamin A palmitate), vitamin E oil(dl-α-tocopherol), vitamin C (ascorbyl tetraisopalmitate) are used effectively. For example, vitamin A has an effect to ease the keratinized skin, to soften the thickened skin and pore walls and to remedy oily corny skin which tends to have pimples.

Vitamin E serves to keep cells young, has effects to improve turnover which causes rough dry skin, wrinkles and the like, and also inhibits brown pigmentation which causes liver spots. Vitamin C prevents the formation of melanin which causes liver spots and freckles and has antioxidant effects to prevent active oxygen which causes liver spots. Ceramide produced by biotechnology has effects to improve the moisture retention function of skin, and the like.

Examples of the beauty treating agent to be contained in the beauty treating chip 10 include a mixture treating agent which is prepared by adding a component (e.g., stearyle glycyrrhizinate) having an anti-inflammation action, which is dissolved in a vegetable oil such as olivescwaran or adsorption purified olive oil, to main target components such as the above various kinds of vitamins and ceramide. Various kinds of fragrances and balm having an aromatherapy effect and pigments may be mixed to the mixture treating agent.

The above mixture treating agent is used for a variety of beauty treating usage depending on the kinds of main target components. The pigments are effective in coloring the beauty treating chip 10 for each purpose of use and improving convenience of the beauty treating chip 10. The above beauty treating agent is just one example, and the beauty treating agent to be contained in the beauty treating chip 10 can be appropriately selected and used depending on the details of a target beauty treatment, a subject treating part, or the like.

For example, the beauty treating chip 10 in which the beauty treating agent is contained is vibrated in reciprocating directions. Specifically, it is mainly vibrated in back and forth directions with respect to a direction of its contact to the skin. And, a frequency and an amplitude are appropriately determined according to the details of the treatment. For example, the frequency of vibration is about 100 to 20000 cycles/min, and the reciprocating vibration has an amplitude of about 0.01 to 100 μm. By applying such fine vibration to the beauty treating chip 10, the beauty treating agent can be efficiently penetrated into the body through the skin surface without damaging the skin. Besides, the fine vibration has a massage effect, and the beauty treating effect can be further improved.

The beauty treating device of this embodiment uses the beauty treating chip 10 in which the beauty treating agent is previously impregnated. And, it is vibrated at a frequency and an amplitude according to the target beauty treating conditions and pushed to the skin surface of the user, so that the beauty treating agent contained in the beauty treating chip 10 is penetrated into the body. Therefore, the beauty treating agent can be penetrated into the body of the user more efficiently than the conventional device which applies vibration after the beauty treating agent is previously applied to the skin. Furthermore, the beauty treating chip 10 is highly safe, and its attack to the skin can be eased by the components contained in the beauty treating agent, so that a load on and a damage to the skin can be relieved furthermore.

By the beauty treating device described above, a beauty treatment for improving, for example, pimpled skin, oily skin, thickened horny skin, dry skin, damaged skin, spotty and freckled skin, dull skin or delicate skin, a beauty treatment for preventing skin from aging, drying or the like, and a variety of treatments for daily beauty, makeup, skin protection and the like can be made effectively and safely. The beauty treating device of the invention is not limited to the above uses and can also be applied to a variety of beauty treatments.

Furthermore, a penetration amount of the beauty treating agent can be controlled by an impregnated amount of the beauty treating agent into the beauty treating chip 10, a frequency and an amplitude to be applied to the beauty treating chip 10, hardness and strength (a worn amount of the chip itself) of the beauty treating chip 10. It is effective to improve the penetration amount of the beauty treating agent and the beauty treating effect based on it. Then, the beauty treating device of this embodiment can be provided at a low cost, so that it can be used not only commercially but also privately. Thus, convenience of the beauty treating device for penetrating the beauty treating agent is improved considerably.

The beauty treating device of this embodiment uses the vibration of the beauty treating chip 10 to penetrate the beauty treating agent, so that not only an effect to improve a penetration efficiency of the beauty treating agent but also a massage effect and a skin regeneration promoting effect based on the vibration of the beauty treating chip 10 can be obtained. Specifically, when the beauty treating chip 10 in which a variety of beauty treating agents are contained is vibrated and pushed to skin, a self-regeneration function (turnover) of skin can be promoted by the effect of the beauty treating agent and the vibration effect. Besides, the capillaries are expanded by the fine vibration to promote bloodstreams (supply of nutrition) and lymph streams (ejection of wastes).

Thus, the promotion of the regeneration function and the like of the skin suppresses liver spots, dullness, wrinkles, and stretch marks. In addition, it is also effective in preventing skin from aging. The beauty treating device of this embodiment provides numerous effects to the beauty treatments such as a skin care treatment.

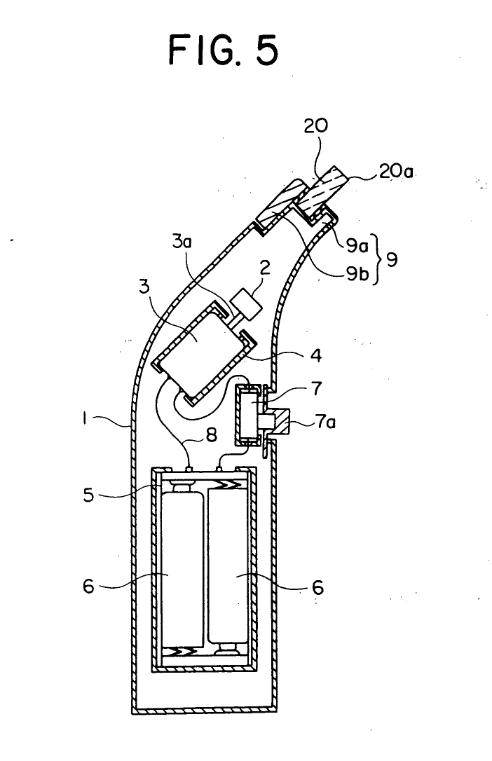

Then, a second beauty treating device of the invention will be described with reference to FIG. 5. FIG. 5 is a sectional view showing an embodiment of the second beauty treating device. Like reference numerals are used for like component parts as those of the beauty treating device of the above-described embodiment and their description is partly omitted.

The beauty treating device shown in FIG. 5 has the device body 1 which has the motor 3 with the eccentric rotor 2 built in it in the same way as the beauty treating device shown in FIG. 2 and FIG. 3. A variety of vibration generating means can be used for the vibration generating section in the same way as the beauty treating device of the aforementioned embodiment. The chip fixing mechanism 9 is mounted at a leading end of the device body 1, and a beauty treating chip 20 is removably held by the chip fixing mechanism 9.

And, vibration generated by the compact DC motor 3 having the eccentric rotor 2 is conducted to the beauty treating chip 20, which is fixed to the device body 1, through the device body 1. This beauty treating device is configured to vibrate the beauty treating chip 20 based on the conduction of vibration through the device body 1 to vibrate at a frequency and an amplitude suitable for the skin regeneration promoting treatment and the removal treatment of dirt adhered to the skin surface. The compact DC motor 3 having the eccentric rotor 2 is determined its position and direction so to mainly apply reciprocating vibration to the beauty treating chip 20 in the direction indicated by the arrow in the drawing.

The beauty treating device of this embodiment removes a part of dirt adhered to the skin surface and aged horny cells by the beauty treating chip 20, which is finely vibrated and moved in closer contact with the skin surface of the user. The beauty treating chip 20 is pushed to the skin of the user so that a corner 20a is mainly contacted to the skin surface. In this state, the beauty treating chip 20 is moved while continuously vibrating to perform the aforementioned skin regeneration promoting treatment and the dirt removing treatment. The beauty treating chip 20 is a chip for removing dirt and aged horny cells.

The tip portion of the device body 1 where the chip fixing mechanism 9 is fitted is inclined toward the lower portion of the device body 1 so that the corner 20a of the beauty treating chip 20 can be easily contacted to the skin surface. In the beauty treating device of this embodiment, the axis of the tip portion with respect to the axis of the lower portion of the device body 1 is set to have an inclination of about 45 degrees.

The beauty treating chip 20 is vibrated mainly in back and forth directions with respect to a direction that it is contacted to the skin. A frequency of the beauty treating chip 20 is preferably determined to be in a range of 500 to 20000 cycles/min. The amplitude of reciprocating vibration of the beauty treating chip 20 is preferably determined to be in a range of 0.01 to 100 μm. Application of fine vibration to the beauty treating chip 20 can uniformly and effectively remove a part of dirt adhered to the skin surface and aged horny cells without damaging the skin.

Specifically, when rotational vibration or the like is applied to the beauty treating chip 20, the skin is partly and deeply ground. Therefore, it is determined that the vibration of the beauty treating chip 20 is reciprocating vibration generated mainly in the back and forth directions with respect to the direction of the skin. Damage to the skin due to such vibration is small, and moreover, the effects of vibration to remove dirt and aged horny cells are remarkable. Besides, when the beauty treating chip 20 is determined to have a higher frequency and a smaller amplitude, a damage to the skin can be reduced furthermore.

When the beauty treating chip 20 has a frequency of less than 500 cycles/min or an amplitude of less than 0.01 Mm, dirt and aged horny cells cannot be removed effectively. Meanwhile, when the frequency exceeds 20000 cycles/min or the amplitude exceeds 100 μm, irritation to the skin might become excessively high. It is more desirable that the beauty treating chip 20 has a frequency of 2000 to 10000 cycles/min. It is more desirable that the beauty treating chip 20 has an amplitude in a range of 0.05 to 10 μm. Such fine vibration is particularly effective in removing horny cells.

The aforementioned beauty treating chip 20 has abrasive grains with a particle size in a range of #80 to #800 according to JIS R6001. In other words, the beauty treating chip 20 is formed of abrasive grains having a particle size in a range of #80 to #800. The abrasive grains configuring the beauty treating chip 20 may be various kinds of hard or semirigid abrasive grains, and it is particularly desirable to use ceramics abrasive grains. Examples of the ceramics abrasive grains include those formed of various ceramics materials such as alumina abrasive grains, zirconia abrasive grains, magnesia abrasive grains, spinel abrasive grains, silicon carbide abrasive grains, or boron nitride abrasive grains.

Among the above ceramics abrasive grains, it is desirable to use abrasive grains formed of an oxide-based ceramics material which is highly safe to the human body, namely at least one kind selected from the group consisting of alumina abrasive grains, zirconia abrasive grains, magnesia abrasive grains and spinel abrasive grains. Especially, the alumina abrasive grains excel in safety and are low in attack to the human body, and also have appropriate performance of removing dirt and horny cells. Therefore, they are suitable for the beauty treating chip 20. As the alumina abrasive grains, brown alumina (A), white alumina (WA), ruby fused alumina (PA), mono-crystalline (fused) alumina (HA), alumina zirconia (AZ) and the like are generally used, but it is particularly desirable to use high-purity white alumina abrasive grains.

The ceramics abrasive grains having a particle size in a range of #80 to #800 deliver effective removing performance when the aforementioned fine vibration at a small amplitude and a high frequency is applied to the beauty treating chip 20 to perform the skin regeneration promoting treatment and the dirt removing treatment. Specifically, the ceramics abrasive grains having an appropriate particle size are low in attack to the skin as compared with the ceramics sintered item and deliver the effective and uniform removing performance by the fine vibration.

When the ceramics abrasive grains have a particle size smaller than #80, the beauty treating chip 20 using them has excessively high surface roughness, and the skin might be damaged heavily when the fine vibration is applied. On the other hand, when the ceramics abrasive grains have a particle size of larger than #800, the performance of removing dirt and aged horny cells lowers, and they cannot be removed uniformly and effectively. The ceramics abrasive grains are desired to have a particle size in a range of #240 to #800 so that damage to the skin can be reduced. Especially, it is desired that the ceramics abrasive grains have a particle size in a range of #240 to #400.

Here, the particle size of the abrasive grains including the ceramics abrasive grains is based on JIS R6001. The ceramics abrasive grains have a particle size in a range of #80 to #220 which is based on the screening method according to JIS R6002, and the ceramics abrasive grains have a particle size in a range of #240 to #800 measured by the electric resistance method or the sedimentation testing method according to JIS R6002. The ceramics abrasive grains having the respective particles sizes basically have a particle diameter as shown in Table 1 (#80 to #220) and Table 2 (#240 to #800).

TABLE 1

| | Standard | | | |
|---|---|---|---|---|
| | screen, | Standard screen and | | |
| | 100% | amount, prescribed | | |
| | passage | amount or more | | Estimate |
| | required | required to remain | | average |
| | Opening of | Opening | | particle |
| Particle | screen | of screen | Amount | diameter |
| size | [size/μm] | [size/μm] | (%) | (μm) |
| #80 | 300 | 180 | 40 | 212 |
| #90 | 250 | 150 | 40 | 178 |
| #100 | 212 | 125 | 40 | 143 |
| #120 | 180 | 106 | 40 | 121 |
| #150 | 150 | 75 | 40 | 97 |
| #180 | 125 | 63 | 40 | 81 |
| #220 | 106 | 53 | 40 | 69 |

TABLE 2

| | | Average |
|---|---|---|
| | Maximum | particle |
| | particle | diameter |
| Particle | diameter | [50% D value] |
| size | (μm) | (μm) |
| #240 | 127 or less | 57 |
| #280 | 112 or less | 48 |
| #320 | 98 or less | 40 |
| #360 | 86 or less | 35 |
| #400 | 75 or less | 30 |
| #500 | 63 or less | 25 |
| #600 | 53 or less | 20 |
| #700 | 45 or less | 17 |
| #800 | 38 or less | 14 |

Specific examples of the beauty treating chip 20 using the ceramics abrasive grains include a whetstone which has the ceramics abrasive grains bonded with a vitrified binder, namely a so-called vitrified whetstone. This whetstone is produced by mixing the ceramics abrasive grains with the vitrified binder, forming the mixture into a desired chip shape and sintering the formed chip at a temperature, for example, in a range of 1200 to 1350° C. Examples of the vitrified binder include SiO₂ and Al₂O₃, and a binder containing MgO, CaO, K₂O and other components as required is used, and its mixing amount is appropriately adjusted. Specifically, it is desirable to determine a type and a mixing amount of the vitrified binder so that the bonding degree (whetstone hardness) of the whetstone falls in a range of A to K.

To produce the vitrified whetstone, it is desirable that an acid treatment is previously performed on the ceramics abrasive grains by using an acid liquid such as hydrochloric acid, sulfuric acid, nitric acid, hydrofluoric acid or a mixture thereof. By the acid treatment of the ceramics abrasive grains, safety (sterilization effect) of the abrasive grains can be improved. Furthermore, because sharp projections and the like on the surface of the abrasive grains can be made smooth to some extent, attack to the skin can be lowered furthermore. This is effective in additionally improving the safety of the beauty treatment using the beauty treating chip 20.

For bonding and holding of the abrasive grains, a binder such as a rubber-based binder, a resin-based binder, a glass-based binder or a metal-based binder other than the vitrified binder may be used. For the beauty treating chip 20, chip-shaped whetstones which are produced by bonding the abrasive grains with any type of binder can be used so that the abrasive grains maintain the chip shape. Among such whetstones, the whetstone using the vitrified binder has appropriate surface roughness and hardness (whetstone bonding degree), so that it is effective in improving an efficiency and safety of the skin regeneration promoting treatment and the dirt removing treatment.

As a specific structure example (Embodiment 1) of the aforementioned beauty treating chip 20, there is a vitrified whetstone which is produced by bonding and holding white alumina abrasive grains having a particle size of #320 with the vitrified binder so to have a whetstone bonding degree (whetstone hardness) of F. The beauty treating chip 20 made of the produced vitrified whetstone was fitted to the device body 1, and its evaluation test was conducted as follows. Vibration of the beauty treating chip 20 was determined to be reciprocating vibration mainly in the back and forth directions with respect to its direction to the skin, a frequency was approximately 6000 cycles/min (motor speed of 6000 rpm) and an amplitude of approximately 0.4 μm.

The evaluation test was performed by preparing an evaluation sample imitating the human skin, vibrating the beauty treating chip 20 under the aforementioned conditions and moving in close contact with the surface of the evaluation sample. The surface of the tested evaluation sample was observed. It was found that portions corresponding to dirt and horny cells were uniformly removed from the sample surface and the tissue below the treated portions did not have any sign of scaling. It was judged from the evaluated results that the beauty treating device of the invention was effective in treating the skin for promoting its regeneration and removal of dirt. And, it was also confirmed that good results were obtained when the skin regeneration promoting treatment was performed on the skin of a subject.

Meanwhile, as a comparative example of the present invention, the same evaluation test as in Embodiment 1 was performed by using a peeling chip (Comparative Example 1) formed of the vitrified whetstone produced in the same manner as in Embodiment 1 except that silicon carbide abrasive grains having a particle size of #60 were used. It was confirmed that not only the portions of the sample surface corresponding to the horny cells and dirt but also the tissues below the treated portions were peeled. Besides, the peeled state of the portion corresponding to the horny cells was not uniform. When a chip (Comparative Example 2) formed of an alumina sintered item was used, it was confirmed that the sample surface had a tendency to be removed nonuniformly to some extent.

According to the beauty treating device of this embodiment, abrasive grains having a particle size in a range of #80 to #800, especially ceramics abrasive grains, are applied to the beauty treating chip 20. Thus, a part of dirt adhered to the skin surface and aged horny cells can be removed uniformly and efficiently without damaging the skin. Besides, alumina abrasive grains are high in safety and low in attack to the human body, so that the beauty treatment can be performed safely even if the user has delicate skin or sensitive skin.

According to the aforementioned beauty treating device, the turnover function of skin can be activated by applying mechanical vibration to the skin by the beauty treating chip 20 and uniformly removing a part of aged horny cells of the skin surface. In other words, the regeneration cycle of skin is promoted, so that liver spots and dullness of skin due to residence of aged horny cells can be removed. Besides, because aged horny cells are piled in wrinkles and stretch marks of epidermis, when the horny cells are removed and the peripheral cells are stimulated, the wrinkles and stretch marks can be relieved. By repeating the above treatment, it is possible to regenerate smooth skin.

Furthermore, capillary vessels are expanded, and bloodstreams (supply of nutrition) and lymph streams (ejection of wastes) are promoted by the fine vibration of the beauty treating chip 20. Thus, the regeneration function of skin is enhanced, and aging of skin can be prevented or inhibited. The beauty treating device of this embodiment provides numerous effects to the beauty treatments such as the skin care treatment. The beauty treating device is particularly suitable for the facial treatment but not limited to it and can also be used for the skin care treatment of various parts of the body.

In the aforementioned embodiment, the beauty treating chip 20 using the ceramics abrasive grains only was described. It is also effective to use, for example, a scrub agent, which is used in a variety of facial wash, in mixture with the ceramics abrasive grains. And, it is preferable to select the scrub agent considering a bonding temperature (whetstone sintering temperature) of the ceramics abrasive grains. For example, a synthetic inorganic scrub agent of silica, calcium carbonate or the like is used. And, a natural-based (animal-based) scrub agent may be used in some instances.

Besides, it is effective to have a beauty liquid such as a facial liquid or a moisturizing liquid and collagen or the like previously applied to or impregnated into the beauty treating chip 20. Collagen beads or the like may be contained in the beauty treating chip 20 depending on a particle diameter. In such a case, a whetstone formed of the ceramics abrasive grains may be formed to have a porous structure and the beauty liquid or collagen may be impregnated into its pores. They can be replenished as required.

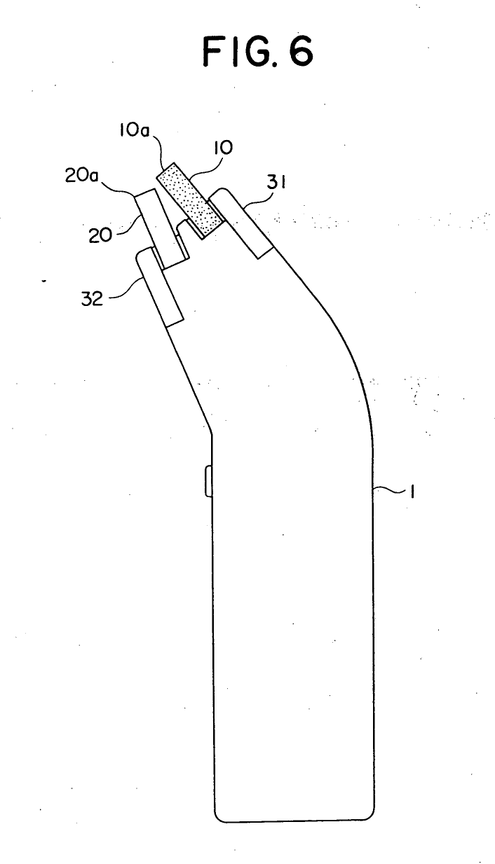

Then, an embodiment of another beauty treating device of the invention will be described with reference to FIG. 6. FIG. 6 is a front view showing a structure of the beauty treating device according to the embodiment of the invention. Like reference numerals are used to denote like component parts as those of the beauty treating device of the aforementioned embodiment and their description is partly omitted.

Though not shown in FIG. 6, the beauty treating device of this embodiment has a vibration generating section of a motor which has an eccentric rotor built in the device body 1 in the same way as in the aforementioned embodiment. A plurality of chip fixing mechanisms 31, 32 are mounted at a leading end of the device body 1. FIG. 6 shows a beauty treating device having two chip fixing mechanisms 31, 32. The chip fixing mechanisms 31, 32 have the same specific structure as the one shown in the aforementioned embodiment.

The first chip fixing mechanism 31 holds as a first beauty treating chip the beauty treating chip 10 which has the beauty treating agent impregnated into the porous base material. A specific structure of the beauty treating chip 10 is the same as in the aforementioned embodiment. Meanwhile, the second chip fixing mechanism 32 holds as the second beauty treating chip the beauty treating chip 20 for removing dirt and aged horny cells. For the beauty treating chip 20, a beauty treating chip which is formed of abrasive grains with a particle size in a range of #80 to #800 in the same way as in the aforementioned embodiment can be used, and a chip formed of a ceramics sintered item can also be used in some cases.

In the beauty treating device of this embodiment, vibration is conducted to the first beauty treating chip 10 and the second beauty treating chip 20. By the second beauty treating chip 20, a part of dirt adhered to the skin surface and horny cells can be removed in the same way as in the aforementioned embodiment. At the same time, the beauty treating agent can be penetrated efficiently by the first beauty treating chip 10. To proceed these two treatments at the same time, the second chip fixing mechanism 32 is disposed at a prescribed angle to the first chip fixing mechanism 31. Specifically, the respective chip fixing mechanisms 31, 32 are determined to have forming angles in such a way that a top surface 10a of the first beauty treating chip 10 and a corner 20a of the second beauty treating chip 20 are simultaneously contacted to the skin surface.

In the aforementioned embodiment, the beauty treating device having the beauty treating chip 10 in which the beauty treating agent is impregnated and the beauty treating chip 20 for removing dirt was described, but a plurality of beauty treating chips mounted on the beauty treating device are not limited to the above chips. The beauty treating device may be provided with, for example, two or more beauty treating chips 10, and the beauty treating chip 20 may be disposed in plural. Besides, another beauty treating chip may be used in addition to the above chips, and three or more beauty treating chips can also be mounted.

### INDUSTRIAL APPLICABILITY

The first beauty treating device of the invention is effectively used for the penetration treatment of a variety of beauty treating agents into the skin. According to the first beauty treating device, controllability of a penetration efficiency and a penetration amount of the beauty treating agent into the skin can be improved at a low cost with convenience for the user improved. Therefore, it is possible to effectively and efficiently perform various beauty treatments. The second beauty treating device of the invention is effectively used for a skin regeneration promoting treatment and a removal treatment of dirt. According to the second beauty treating device, the promotion effect of the skin regenerating function and the dirt removing effect can be improved while suppressing a damage to the skin.

What is claimed is:

1. A beauty treating device, comprising:
a device body;
a vibration generating section which is built in the device body; and
a beauty treating chip, to which vibration is conducted from the vibration generating section, which is contacted to a surface of skin to be undergone beauty treatment to apply the vibration to it, and which has a porous base material and a beauty treating agent impregnated into the porous base material.

2. The beauty treating device according to claim 1, wherein the beauty treating agent contains at least one kind selected from the group consisting of a beauty component, a cosmetic component and a skin protecting component.

3. The beauty treating device according to claim 2, wherein the beauty treating agent further contains at least one kind selected from fragrances and pigments.

4. The beauty treating device according to claim 1, wherein the porous base material is formed of porous ceramics, porous resin or porous rubber.

5. The beauty treating device according to claim 1, wherein the porous base material is formed of a porous aggregate or porous sintered body of a ceramics material.

6. The beauty treating device according to claim 1, wherein the vibration generating section applies mainly reciprocating vibration to the beauty treating chip.

7. The beauty treating device according to claim 1, further comprising a second beauty treating chip for removing dirt adhered to the surface of skin and/or a portion of aged skin.

8. The beauty treating device according to claim 7, wherein the second beauty treating chip is provided with abrasive grains having a grain size in a range of #80 to #800 according to JIS R6001.

9. The beauty treating device according to claim 8, wherein the second beauty treating chip has the abrasive grains and a binder for binding the abrasive grains in such a way that the abrasive grains retain the chip shape.

10. A beauty treating device, comprising:
a device body;
a vibration generating section which is built in the device body; and
a beauty treating chip, to which vibration is conducted from the vibration generating section, which is contacted to a surface of skin to be undergone a beauty treatment to apply the vibration to it, and which is provided with abrasive grains having a grain size in a range of #80 to #800 according to JIS R6001.

11. The beauty treating device according to claim 10, wherein the abrasive grains have a grain size in a range of #240 to #800.

12. The beauty treating device according to claim 10, wherein the beauty treating chip has the abrasive grains and a binder for binding the abrasive grains in such a way that the abrasive grains retain the chip shape.

13. The beauty treating device according to claim 10, wherein the abrasive grains are ceramics abrasive grains.

14. The beauty treating device according to claim 13, wherein the ceramics abrasive grains are at least one kind selected from the group consisting of alumina abrasive grains, zirconia abrasive grains, magnesia abrasive grains and spinel abrasive grains.

15. The beauty treating device according to claim 13, wherein the ceramics abrasive grains are treated with acid.

16. The beauty treating device according to claim 10, wherein the vibration generating section applies mainly reciprocating vibration to the beauty treating chip.

17. The beauty treating device according to claim 16, wherein the vibration generating section vibrates the beauty treating chip at a frequency in a range of 500 to 20000 cycles/min.

18. The beauty treating device according to claim 16, wherein the vibration generating section vibrates the beauty treating chip at an amplitude of vibration in a range of 0.01 to 100 μm.

19. The beauty treating device according to claim 10, wherein the beauty treating chip is contacted to the surface of skin to remove dirt adhered to the surface of skin and/or a portion of aged skin.

20. A beauty treating device, comprising:
a device body;
a vibration generating section which is built in the device body; and
a beauty treating chip to which vibration is conducted from the vibration generating section, which is contacted to the surface of skin to be undergone a beauty treatment to apply the vibration to it, and which has alumina abrasive grains.

21. The beauty treating device according to claim 20, wherein the beauty treating chip has the alumina abrasive grains and a binder for binding the alumina abrasive grains in such a way that the alumina abrasive grains retain the chip shape.

22. A beauty treating chip for penetrating a beauty treating agent into body to contact a surface of skin of the body, comprising:
a porous base material; and
the beauty treating agent impregnated into the porous base material.

23. The beauty treating chip according to claim 22, wherein the beauty treating agent contains at least one kind selected from the group consisting of a beauty component, a cosmetic component and a skin protecting component.

24. The beauty treating chip according to claim 23, wherein the beauty treating agent further contains at least one kind selected from fragrances and pigments.

25. The beauty treating chip according to claim 22, wherein the porous base material is formed of a porous aggregate or porous sintered body of a ceramics material.
